(19) United States
(12) Patent Application Publication
(10) Pub. No.: US 2009/0020104 A1
(43) Pub. Date: Jan. 22, 2009

(54) FUEL SUPPLY TANK, FUEL SUPPLY SYSTEM AND FUEL INJECTION APPARATUS FOR THE SYSTEM

(75) Inventors: Toshio Karasawa, Kanagawa (JP); Shogo Hashimoto, Kanagawa (JP)

Correspondence Address: WENDEROTH, LIND & PONACK, L.L.P., 2033 K STREET N. W., SUITE 800, WASHINGTON, DC, 20006-1021, US

(73) Assignee: MIKUNI CORPORATION, Tokyo, JP (JP)

(21) Appl. No.: 11/816,831

(22) PCT Filed: Mar. 24, 2006
(86) PCT No.: PCT/JP2006/305998

§ 371 Date: Aug. 22, 2007

(30) Foreign Application Priority Data
Mar. 25, 2005 (JP) 2005-089504

(51) Int. Cl. F02M 5/00

(52) U.S. Cl. 123/530

(57) ABSTRACT

A fuel supply tank, comprising a tank body 7 which stores fuel, a fuel filter 13 disposed in the tank body 7, a fuel supply passage 27 for supplying fuel in the tank body 7 to a fuel injection apparatus 3, a fuel return passage 29 for returning excess fuel and vapor from the fuel injection apparatus 3 into the tank body 7. The fuel supply passage 27 and the fuel return passage 29 are connected to the clean fuel room 23 which is defined by the fuel filter 13, and separation of fuel and vapor is performed in the clean fuel room 23.

### TECHNICAL FIELD

The present invention relates to a fuel supply tank, a fuel supply system and a fuel injection apparatus used in the fuel supply system for supplying fuel to small internal combustion engines which are adopted to motorcycles etc, for example. It especially relates to a fuel supply tank, a fuel supply system and a fuel injection apparatus which can reliably separate vapor in the fuel, simplify the overall structure, and prevent excess fuel returned to the fuel supply tank to heat the fuel in the tank.

### BACKGROUND ART

Recently, fuel injection apparatus are being proposed to small engines which are adopted to motorcycles etc. For example, such an apparatus is disclosed in Japanese Patent Laid-open 2003-129912, Patent Document 1.

In Patent Document 1, a pump injector in which a fuel pump and an injection nozzle are integrated is disclosed. Fuel is supplied to the pump injector by an assist pump which is connected to the fuel tank. A filter is disposed at some midpoint of a pipe to connect the assist pump and the pump injector. Then, excess fuel supplied to the pump injector is returned to the fuel tank through a return pipe.

The assist pump, the filter, and the pump injector are disposed separately in the abovementioned structure. In order to simplify the overall structure, further improvement is required. In addition, there is a problem that fuel in the fuel tank is heated by the returned fuel through the return pipe.

The present invention is devised to solve the abovementioned problems. The purpose of the present invention is to supply a fuel supply tank, a fuel supply system and a fuel injection apparatus used in the system which can simplify the overall structure and prevent heating of the fuel in the tank by returned fuel without the returned fuel diffusing in the tank.

Further, the purpose of the present invention is to supply a fuel supply tank, a fuel supply system and a fuel injection apparatus used in the system which can easily separate vapor from the returned fuel.

### DISCLOSURE OF THE INVENTION

To achieve the abovementioned object, a fuel tank of claim 1 of the present invention comprises a tank body which stores fuel, a fuel filter disposed in the tank body, a fuel supply passage for supplying fuel in the tank body to a fuel injection apparatus, a fuel return passage for returning excess fuel and vapor from the fuel injection apparatus into the tank body, a clean fuel room defined by the fuel filter, and a clean fuel room defined by the fuel filter to which the fuel supply passage and the fuel return passage are connected and in which separation of fuel and vapor is performed.

In the fuel supply tank of claim 2 which depends on claim 1, the fuel filter is approximately cylindrical and the inner diameter is equal to or larger than 10 mm.

The fuel supply tank of claim 3 which depends on claim 1 or claim 2 further comprises an inlet passage disposed at the tank body to inlet fuel from a main tank, and an outlet passage disposed at the tank body to return overflowing fuel at the tank body to the main tank.

In the fuel supply tank of claim 4 which depends on any one of claims 1 through 3, an inlet port of the fuel supply passage and an outlet port of the fuel return passage are positioned adjacently and opposedly to each other.

The fuel supply tank of claim 5 which depends on any one of claims 1 through 4 further comprises a vent port disposed at the upper portion of the clean fuel room.

A fuel supply system of claim 6 comprises a tank body which stores fuel, a fuel filter disposed in the tank body, a fuel supply passage for supplying fuel in the tank body to a fuel injection apparatus, a fuel return passage for returning excess fuel and vapor from the fuel injection apparatus into the tank body, a clean fuel room defined by the fuel filter, to which the fuel supply passage and the fuel return passage are connected, and in which separation of fuel and vapor is performed, and the fuel injection apparatus to inject fuel to an internal combustion engine.

In the fuel supply system of claim 7 which depends on claim 6, the fuel injection apparatus is a self-pressurizing type having a plunger being free to reciprocate to pressurize the fuel which flows into a pressurizing room from an inlet port, and the plunger has a relief portion formed at the tip of the plunger to relieve a vapor eject hole which is connected to the pressurizing room.

A fuel injection apparatus of claim 8 comprises a plunger being free to reciprocate to pressurize the fuel which flows into a pressurizing room from an inlet port for injecting fuel to an internal combustion engine, and a relief portion formed at the tip of the plunger to relieve a vapor eject hole which is connected to the pressurizing room.

With claims 1 through 8 of the present invention, a fuel filter is disposed in the tank body, and a fuel supply passage for supplying fuel to the fuel injection apparatus and a fuel return passage from the fuel injection apparatus are connected to a clean fuel room which is defined by the fuel filter. Therefore, the overall structure can be simplified.

Further, heating of the fuel in the tank by returned fuel can be prevented without the returned fuel diffusing in the tank.

Furthermore, vapor which is returned with fuel can easily be separated.

### BRIEF DESCRIPTION OF THE DRAWINGS

FIG. 1 is an illustrative drawing which conceptually and schematically shows an embodiment of the fuel supply system of the present invention.

FIG. 2 is a detailed illustrative drawing which conceptually and schematically shows a section of the fuel injection apparatus of FIG. 1.

### BEST MODE FOR CARRYING OUT THE INVENTION

In the following, an embodiment of the present invention is explained with reference to the drawings.

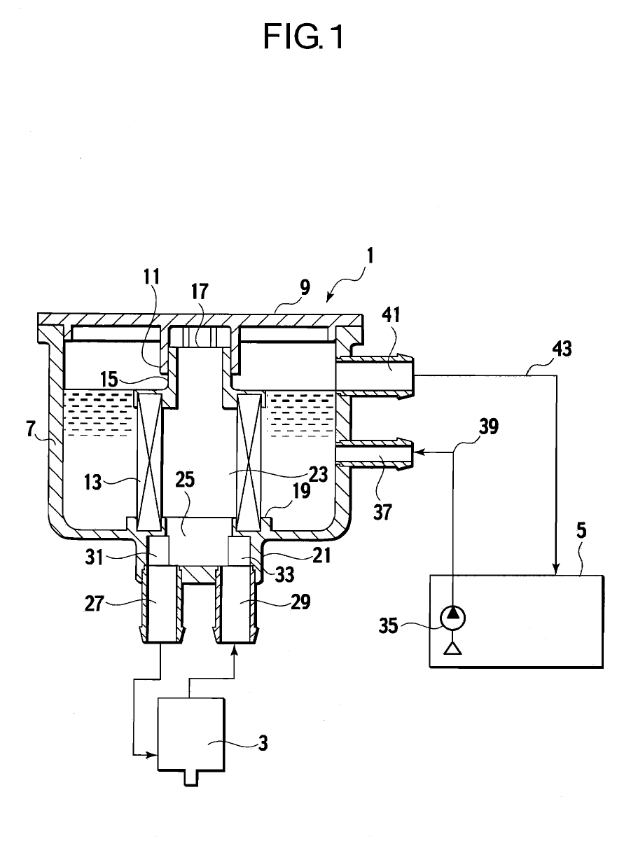

As conceptually and schematically shown in FIG. 1, the fuel supply system of the embodiment of the present invention comprises a fuel supply tank 1, and a fuel injection apparatus (an injector) 3 to inject fuel to a small internal combustion engine (not shown in the drawing) for a motorcycle, an outboard and so on. The details of the fuel injection apparatus are explained later. Here, according to the capacity of the fuel supply tank 1, disposing a main tank 5 which can store enough amount of fuel is preferred.

As shown in FIG. 1, the fuel supply tank 1 comprises a tank body 7 which stores liquid fuel such as gasoline etc. The upper part of the tank body 7 is covered with a cover member 9. A filter holder 15 which supports the upper part of an approximately cylindrical fuel filter 13 is fitted to a cylindrical fit portion 11 which is disposed at the center of the cover member 9.

Then, a vent port for discharging gas is disposed at the upper part of the filter holder 15. Specifically, a gas-liquid separation means 17 is disposed between the filter holder 15 and the end of the fit portion 11 to allow discharging of gas into the tank body 7 through the clearance between the filter holder 15 and the fit portion 11 and to prevent liquid fuel from flowing into the filter holder 15. As for the gas-liquid separation means 17, an appropriate filter or a gas-liquid separation membrane etc. which allows gas to pass but prevents liquid from passing can be adopted.

A lower project portion 21 which projects towards the lower direction is formed at the lower surface of the bottom of the tank body 7 in correspondence to a fit support portion 19 to which the bottom of the fuel filter 13 is fitted and supported. A communication hole 25 which communicates to the inner room 23 of the fuel filter 13 is formed at the center of the lower project portion 21. Then, a fuel supply passage 27 to supply fuel to the injector (namely, fuel injection apparatus) 3 and a fuel return passage 29 to return excess fuel from the injector 3 and vapor generated in the fuel are connected to the communication hole 25.

An inlet port 31 of the fuel supply passage 27 and an outlet port 33 of the fuel return passage 29 are disposed symmetrically and opposedly to each other. In other words, the fuel supply passage 27 and the inlet port 31 are formed symmetrically to and disposed adjacently to the fuel return passage 29 and the outlet port 33. Therefore, the fuel supply passage 27 and the fuel return passage 29 do not have to be previously determined. The passage connected to the fuel inlet side of the injector 3 is the fuel supply passage 27, and the passage connected to the fuel return side of the injector 3 is the fuel return passage 29. In this manner, the connection to the injector 3 can be easily performed.

Here, the inner room 23 surrounded by the fuel filter 13 constitutes a clean fuel room which stores clean fuel filtered by the fuel filter 13. Namely, the clean fuel room 23 is defined by the fuel filter 13 to prevent excess fuel returned from the injector 3 through the fuel return passage 29 from diffusing into the tank body 7. The inner diameter of the fuel filter 13 is composed to be equal to or larger than approximately 10 mm so that the vapor returned with the excess fuel through the injector 3 can be separated easily.

With the inner diameter of the fuel filter 13 being smaller than approximately 10 mm, the fuel in the fuel filter 13 tends to rise along with the vapor when the vapor generated in the fuel rises to be separated from the fuel. Therefore, it is preferred that the inner diameter of the fuel filter 13 is equal to or larger than approximately 10 mm. In addition, although it depends the thickness of the fuel filter 13 and the size of the tank body 7, it is preferred that the inner diameter of the fuel filter 13 is equal to or smaller than approximately 30 mm so that the whole structure does not upsize.

With the abovementioned structure, when fuel injection to an engine is performed by operating the injector 3, fuel in the clean fuel room (namely, the inner room) 23 which is defined by the fuel filter 13 is supplied to the injector 3 through the fuel supply passage 27. Then, excess fuel and vapor generated in the heated fuel at the injector 3 which is heated by the engine are returned into the communication hole 25 and the clean fuel room 23 through the fuel return passage 29.

The vapor is separated from the fuel by rising in the communication hole and the clean fuel room 23. There is a tendency that the fuel in the communication hole 25 and the clean fuel room 23 rises when the vapor rises. However, since the diameter of the clean fuel room 23 is large as being equal to or larger than approximately 10 mm, the fuel does not rise along with the vapor. Thus, smooth separation can be performed. Namely, the vapor-lock phenomenon does not appear. Further, since the outlet port 33 and the inlet port 31 are disposed adjacently and opposedly to each other, the warm fuel returned through the fuel return passage 29 tends to be sucked from the inlet port 31 after the vapor rises. Furthermore, since the clean fuel room 23 is defined by the fuel filter 13, the warm fuel does not diffuse into the tank body 7 and does not warm the fuel in the tank body 7.

Here, in the case that the capacity of the fuel supply tank 1 is small, disposing the main tank 5 which can store enough amount of fuel is preferred. Then, a fuel pump 35 is disposed inside or outside the main tank 5 to supply fuel from the main tank 5 into the tank body 7. The fuel pump 35 is connected to an inlet passage 37 disposed at the tank body 7 through an inlet path (namely, an inlet pipe) 39. The main tank 5 is connected to an outlet passage 41 which is used for overflowing and disposed above the inlet passage 37 through an outlet path 43.

As explained above, the clean fuel room 23 defined by the fuel filter 13 is disposed in the tank body 7 of the fuel supply tank 1. Then, the fuel supply passage 27 for supplying fuel to the injector 3 and the fuel return passage 29 for returning the excess fuel from the injector 3 are connected to the clean fuel room 23. Therefore, the overall structure can be simplified. Further, by preventing diffusion of the returned fuel in the tank body 7, the fuel in the tank body 7 can be prevented from heating. Furthermore, since the inlet port 31 and the outlet port 33 are formed symmetrically and disposed adjacently to each other, the structure of the mold for manufacturing the tank body 7 by injection molding can be simplified.

In the abovementioned explanation, the fuel filter 13 is formed as a cylinder. However, not limited to this structure, it is also possible to adopt the structure of merely separating the tank body 7 into the fuel room and the clean fuel room 23 by the fuel filter 13, for example. Further, depending on the case, it is also possible to form the fuel filter 13 as a dome. Namely, various structures can be adopted to define the clean fuel room 23 by the fuel filter 13 in the tank body 7.

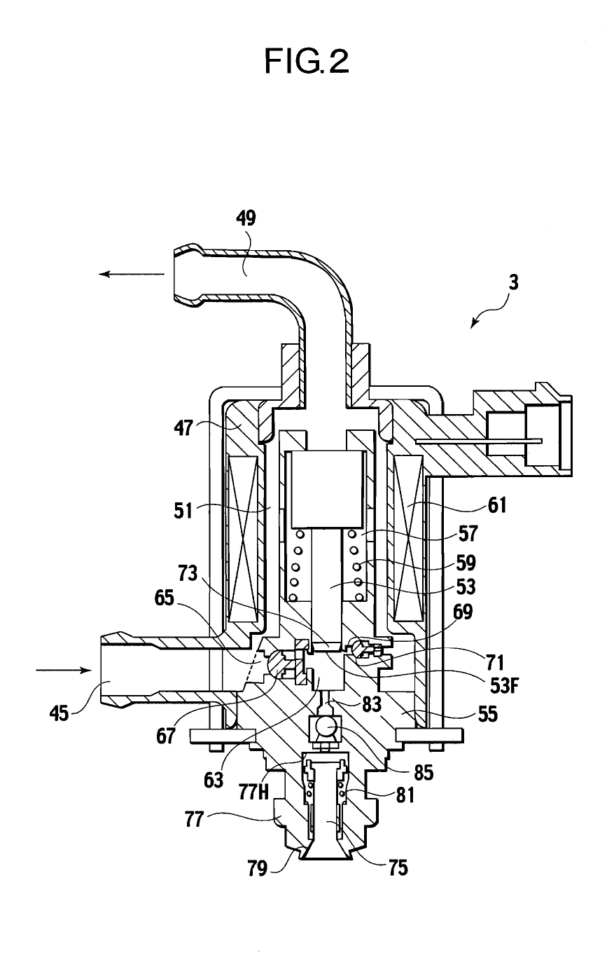

As conceptually and schematically shown in FIG. 2, the injector 3 comprises a housing 47 which has an inlet port 45 connecting to the fuel supply passage 27 of the fuel supply tank 1 through piping. An outlet port 49 which connects to the fuel return passage 29 of the fuel supply tank 1 is disposed at the upper part of the housing 47. Then, a communication inner hole 51 which connects the inlet port 45 and the outlet port 49 is formed within the housing 47.

A unit housing 55 having a plunger 53 which is free to reciprocate is disposed by fitting in the communication inner hole 51. An elastic member 59 such as a return spring is disposed between the bottom portion of a plunger accommodation portion 57 and the plunger 53 which is free to reciprocate disposed in the plunger accommodation portion 57 formed in the unit housing 55. The plunger 53 is always urged upwards in FIG. 2. Further, an operation coil 61 is disposed at the housing 47 to quickly move the plunger 53 against the urging force of the elastic member 59 downwards in FIG. 2.

A pressurizing room 63 is formed at the unit housing 55 in correspondence to the top end of the plunger 53. An inlet port 65 connecting to the inlet port 45 of the housing 47 and the communication inner hole 51 is formed at the pressurizing room 63. A check valve 67 which allows fuel inlet to the pressurizing room 63 and prevents outlet from the pressurizing room 63 is disposed at the inlet port 65. Further, a narrow vapor eject hole 69 is disposed horizontally at the pressurizing room 63 at almost the same height with the tip surface (namely, the bottom end surface) 53F of the plunger 53 in the condition that the plunger 53 is raised by the elastic member 59.

The vapor eject hole 69 communicates with the communication inner hole 51 for ejecting vapor generated in the fuel heated in the pressurizing room 63. A check valve 71 which allows outlet of fuel and vapor and prevents inlet of fuel and vapor to the communication inner hole 51 from the pressurizing room 63 is disposed at the vapor eject hole 69.

A taper portion is formed as an example of a relief portion 73 at the tip of the plunger 53 to prevent the contact of the edge portion of the vapor eject hole 69 and the tip edge portion of the plunger 53. Here, not limited to the taper portion as the relief portion 73, it is also possible to form a slight step portion at the vicinity of the tip by grinding the outside surface of the tip.

The relief amount of the relief portion 73 is preferred to have the range of 3 through 10 μm. In the case that the relief amount is too small, the prevention of the contact may not be sufficient. In the case that the relief amount is too large, the fuel injection amount may be affected.

A nozzle unit 77 integrally accommodating a poppet valve 75 which is free to move upwards and downwards is disposed at the bottom end of the unit housing 55. Specifically, inside the inner hole 77H which is formed at the nozzle unit 77, the poppet vale 75 is accommodated to be free to move upwards and downwards to open and close a nozzle hole 79 which is formed at the nozzle unit 77. The poppet valve 75 is always urged upwards by the urging force of an elastic member 81 such as a return spring which is disposed in the nozzle unit 77. The inner hole 77H and the pressurizing room 63 are connected through an orifice 83 and a check valve 85.

As for the injector 3, when the operation coil 61 is powered to quickly move the plunger 53 downwards against the urging force of the elastic member 59, the fuel in the pressurizing room 63 is pressurized by the plunger 63 and flows into the inner hole 77H of the nozzle unit 77. At the inner hole 77H, when the poppet valve 75 is moved downwards by the pressure to the upper face of the poppet valve 75 against the urging force of the elastic member 81, the nozzle hole 79 is opened and fuel is injected to the engine.

When the plunger 53 moves downwards as mentioned above, the vapor generated in the fuel in the pressurizing room 63 is accumulated around the vapor eject hole 69 and ejected through the vapor eject hole 69 to the communication inner hole 51. Then, the vapor ejected into the communication inner hole 51 is returned into the clean fuel room 23 from the outlet port 49 through the fuel return passage 29 of the fuel supply tank 1 together with the excess fuel flowing from the inlet port 45. In this manner, the separation of fuel and vapor is performed.

Since the relief portion 73 such as a taper portion etc. is formed at the tip of the plunger 53, there is no contact between the edge portion of the vapor eject hole 69 and the edge portion of the tip of the plunger 53 when the plunger 53 is moved downwards. Therefore, there is no change in the sliding resistance caused by this contact, and the plunger 53 slides stably. Thus, slight variations in the fuel injection amount caused by the change in the sliding resistance of the plunger 53 can be prevented. Therefore, the accuracy of the injection amount can be improved.

When the operation coil 61 is unpowered and the plunger 53 returns upwards by the elastic member 59, negative pressure is generated in the pressurizing room 63. Then, fuel is newly sucked from the inlet port 65 to return to the initial state.

With the abovementioned injector 3, vapor generated in fuel can easily be ejected while simplification of the overall structure can be achieved. Further, the accuracy of the fuel injection amount can be improved.

This application contains all description of Japanese Patent Application 2005-089504 (filed in Mar. 25, 2005) as referenced.

The present invention is not limited to the abovementioned embodiment. It is also possible to adopt various embodiments by applying the appropriate changes needed.

1. A fuel supply tank, comprising:
a tank body which stores fuel;
a fuel filter disposed in said tank body;
a fuel supply passage for supplying fuel in said tank body to a fuel injection apparatus;
a fuel return passage for returning excess fuel and vapor from said fuel injection apparatus into said tank body;
a clean fuel room defined by said fuel filter; and
a clean fuel room defined by said fuel filter, to which said fuel supply passage and said fuel return passage are connected, and in which separation of fuel and vapor is performed.

2. The fuel supply tank according to claim 1, wherein said fuel filter is approximately cylindrical and the inner diameter is equal to or larger than 10 mm.

3. The fuel supply tank according to claim 1, further comprising;
an inlet passage disposed at said tank body to inlet fuel from a main tank; and
an outlet passage disposed at said tank body to return overflowing fuel at said tank body to said main tank.

4. The fuel supply tank according to claim 1, wherein an inlet port of said fuel supply passage and an outlet port of said fuel return passage are positioned adjacently and opposedly to each other.

5. The fuel supply tank according to claim 1, further comprising a vent port disposed at the upper portion of said clean fuel room.

6. A fuel supply system, comprising:
a tank body which stores fuel;
a fuel filter disposed in said tank body;
a fuel supply passage for supplying fuel in said tank body to a fuel injection apparatus;
a fuel return passage for returning excess fuel and vapor from said fuel injection apparatus into said tank body;
a clean fuel room defined by said fuel filter, to which said fuel supply passage and said fuel return passage are connected, and in which separation of fuel and vapor is performed; and
said fuel injection apparatus to inject fuel to an internal combustion engine.

7. The fuel supply system according to claim 6, wherein said fuel injection apparatus is a self-pressurizing type having a plunger being free to reciprocate to pressurize the fuel which flows into a pressurizing room from an inlet port, and said plunger has a relief portion formed at the tip of said plunger to relieve a vapor eject hole which is connected to said pressurizing room.

8. A fuel injection apparatus, comprising:
a plunger being free to reciprocate to pressurize the fuel which flows into a pressurizing room from an inlet port for injecting fuel to an internal combustion engine, and
a relief portion formed at the tip of said plunger to relieve a vapor eject hole which is connected to said pressurizing room.

9. The fuel supply tank according to claim 2, further comprising;
an inlet passage disposed at said tank body to inlet fuel from a main tank; and
an outlet passage disposed at said tank body to return overflowing fuel at said tank body to said main tank.

10. The fuel supply tank according to claim 2, wherein an inlet port of said fuel supply passage and an outlet port of said fuel return passage are positioned adjacently and opposedly to each other.

11. The fuel supply tank according to claim 3, wherein an inlet port of said fuel supply passage and an outlet port of said fuel return passage are positioned adjacently and opposedly to each other.

12. The fuel supply tank according to claim 2, further comprising a vent port disposed at the upper portion of said clean fuel room.

13. The fuel supply tank according to claim 3, further comprising a vent port disposed at the upper portion of said clean fuel room.

14. The fuel supply tank according to claim 4, further comprising a vent port disposed at the upper portion of said clean fuel room.
